(19) United States
(12) Patent Application Publication
(10) Pub. No.: US 2009/0012697 A1
(43) Pub. Date: Jan. 8, 2009

(54) Vehicle and Control Device and Control Method for the Same

(75) Inventors: Kazuo NAKAMURA, Shizuoka (JP); Hitoshi SAKURAI, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/105,181

(22) Filed: Apr. 17, 2008

(30) Foreign Application Priority Data
Apr. 17, 2007 (JP) 2007-107737

(51) Int. Cl. F02D 45/00

(52) U.S. Cl. 701/103

(57) ABSTRACT

A motorcycle includes a fuel supply device that supplies fuel to an intake passage, an ECU that controls an opening/closing valve that opens and closes the intake passage, an exhaust gas passage, a catalyst disposed inside the exhaust gas passage, and a switch of an engine. When the engine rotation speed is equal to or more than a determined rotation speed when the switch is turned off, the opening/closing valve is switched on to close the intake passage. When the engine rotation speed is less than the determined rotation speed, the opening/closing valve is switched off to open the intake passage. Thermal degradation of a catalyst is thereby inhibited and electric power consumption is reduced when an engine is turned off.

### RELATED APPLICATIONS

This application claims the benefit of priority under 35 USC 119 of Japanese patent application no. 2007-107737, filed on Apr. 17, 2007, which application is hereby incorporated by reference in its entirety.

### BACKGROUND OF THE INVENTION

1. Field of the Invention

The present invention relates to a control device and method for the vehicle.

2. Description of Related Art

Vehicles using a carburetor, which is a mechanical vaporizing device, are known. In a vehicle using a carburetor, depending on the combustion state of an engine, a catalyst provided in an exhaust gas passage may be burned or suffer degradation. More specifically, when the ignition is cut, for example, when the engine over-revs and the engine speed exceeds an allowable maximum rotation speed, or when the engine is turned off while moving, unburned fuel may flow into the exhaust gas passage. Unburned fuel that flows into the exhaust gas passage may self-ignite and cause the catalyst to be burned or suffer thermal degradation.

For example, JP-UM-B-6-619 discloses a fuel control device that performs a fuel cut in accordance with an engine state when an engine stop operation is performed. More particularly, JP-UM-B-6-619 relates to a fuel control device for a stationary operation engine like an engine generator or a lawn mower. The fuel control device disclosed in JP-UM-B-6-619 is applied to an engine that is turned off by cutting fuel using an electromagnetic cock. When the electromagnetic cock is switched off to turn off the engine, a fuel cut is performed by a solenoid valve until the engine rotation speed becomes equal to or less than a determined rotation speed.

The fuel control device for the stationary operation engine of JP-UM-B-6-619 could be applied to an engine for a vehicle. More particularly, when the engine is turned off, burning or thermal degradation of a catalyst may be inhibited by performing a fuel cut until a rotation speed of the engine becomes equal to or less than a determined rotation speed.

However, in a vehicle, when the engine is turned off, if a fuel cut is performed until the rotation speed of the engine becomes equal to or less than the determined rotation speed, a solenoid valve will be turned on. Thus, even though the catalyst is not substantially degraded, electric power is supplied to opening/closing valves like a solenoid valve, thereby increasing electric power consumption of the battery.

Increased electric power consumption of the battery is a big issue for a small size vehicle that is equipped with a small battery, for example, a vehicle with a displacement of 250 cc or less.

### SUMMARY OF THE INVENTION

The invention addresses these problems and inhibits thermal degradation of a catalyst while reducing electric power consumption when an engine is turned off.

A vehicle according to the invention is provided with a fuel tank, an engine, an intake passage, a fuel supply device, an electronically controlled opening/closing valve, a control unit, an exhaust gas passage, a catalyst, a switch and a rotation speed sensor. The fuel tank stores fuel. The intake passage supplies air to the engine. The fuel supply device is connected to the fuel tank and supplies the fuel to the intake passage. The opening/closing valve is controlled by the control unit to open and close the intake passage. The exhaust gas passage is connected to the engine and acts a passage through which exhaust gas from the engine passes. The catalyst is disposed inside the exhaust gas passage. The switch turns on/off the engine. The rotation speed sensor detects a rotation speed of the engine and outputs the detected rotation speed to the control unit. The control unit includes a determination unit and a valve drive unit. The determination unit determines whether the rotation speed of the engine is equal to or more than a determined rotation speed when the switch is turned off. The valve drive unit switches the opening/closing valve on to close the intake passage when the determination unit determines that the rotation speed of the engine is equal to or more than the determined rotation speed, and switches the opening/closing valve off to open the intake passage when the determination unit determines that the rotation speed of the engine is less than the determined rotation speed.

A control device according to the invention is for a vehicle having a fuel tank that stores fuel; an engine; an intake passage that supplies air to the engine; a fuel supply device that is connected to the fuel tank and supplies the fuel to the intake passage; an electronically controlled opening/closing valve that opens and closes the intake passage; an exhaust gas passage that is connected to the engine and through which exhaust gas from the engine passes; a catalyst disposed inside the exhaust gas passage; a switch that turns on/off the engine; and a rotation speed sensor that detects a rotation speed of the engine.

The control device according to the invention is provided with a determination unit and a valve drive unit. The determination unit determines whether the rotation speed of the engine is equal to or more than a determined rotation speed when the switch is turned off. The valve drive unit switches the opening/closing valve on to close the intake passage when the determination unit determines that the rotation speed of the engine is equal to or more than the determined rotation speed, and switches the opening/closing valve off to open the intake passage when the determination unit determines that the rotation speed of the engine is less than the determined rotation speed.

A control method according to the invention is for a vehicle having a fuel tank that stores fuel; an engine; an intake passage that supplies air to the engine; a fuel supply device that is connected to the fuel tank and supplies the fuel to the intake passage; an electronically controlled opening/closing valve that opens and closes the intake passage; an exhaust gas passage that is connected to the engine and through which exhaust gas from the engine passes; a catalyst disposed inside the exhaust gas passage; a switch that turns on/off the engine; and a rotation speed sensor that detects a rotation speed of the engine.

In the control method according to the invention the opening/closing valve is switched on to close the intake passage when the rotation speed of the engine is equal to or more than the determined rotation speed when the switch is turned off, and is switched off to open the intake passage when the rotation speed of the engine is less than the determined rotation speed.

According to the invention, thermal degradation of a catalyst is inhibited and electric power consumption is reduced when an engine is turned off.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a side view of a motorcycle according to the invention.

FIG. 2 is a schematic structural view of an engine and the vicinity of an ECU.

FIG. 3 is a block diagram of a control system of the motorcycle.

FIG. 4 is a flow chart of the operation of an opening/closing valve.

### DETAILED DESCRIPTION OF THE INVENTION

### Schematic Structure of Motorcycle 1

A motorcycle 1 according to an embodiment of the invention is now described with reference to the drawings. Motorcycle 1 is just one example of a vehicle, and the invention is not limited to this. A vehicle according to the invention may be a straddle-type vehicle other than a motorcycle, such as an ATV (All Terrain Vehicle) and the like.

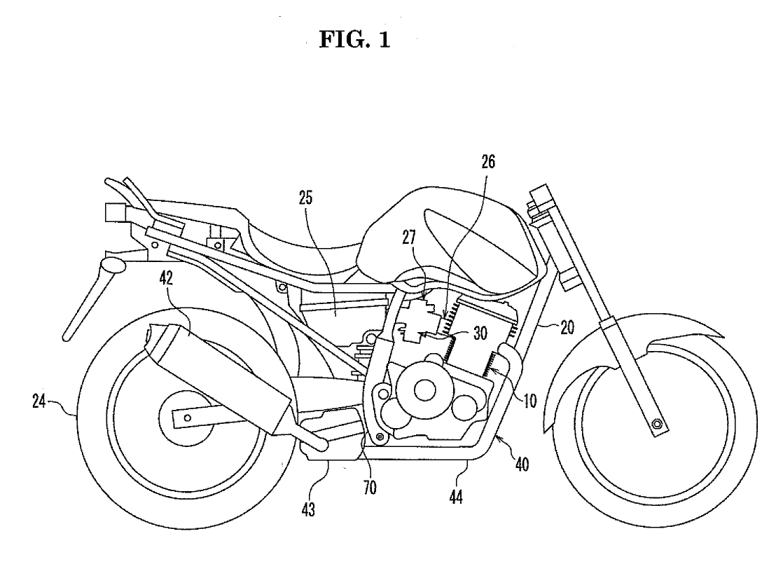

As shown in FIG. 1, motorcycle 1 includes an engine 10 suspended from a body frame 21. For sake of explanatory convenience, a handle is not illustrated. Engine 10 is connected to a rear wheel 24 via power transmission means such as a transmission, a clutch, a chain, a drive shaft, etc.

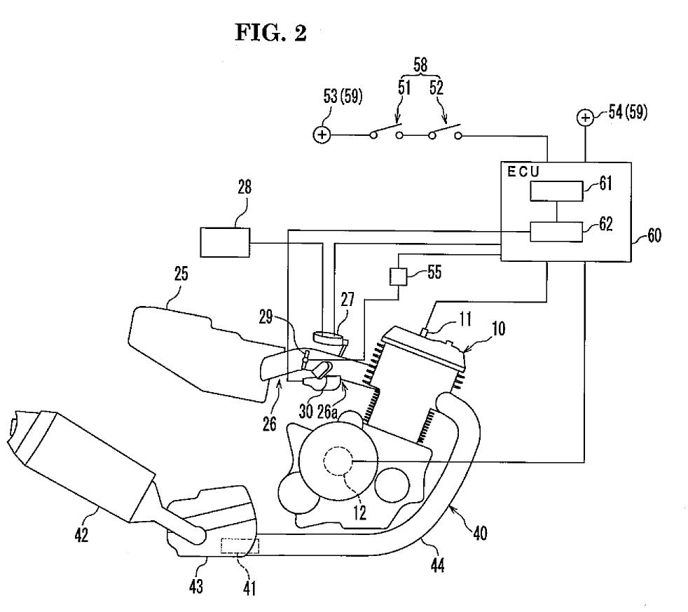

As shown in FIG. 2, engine 10 is connected to an air cleaner 25 via an intake passage 26. Air cleaner 25 cleans air introduced from an intake port formed in air cleaner 25. Air cleaned by air cleaner 25 is supplied to a combustion chamber of engine 10 via intake passage 26.

A carburetor 27 serving as a fuel supply device is provided at an intermediate section of intake passage 26. Carburetor 27 is connected to a fuel tank 28 in which fuel, such as gasoline, is stored. Carburetor 27 supplies fuel from fuel tank 28 to intake passage 26. The section of intake passage 26 to which carburetor 27 is connected is a venturi section 26a having an inside diameter smaller than that of other sections. When engine 10 is driven, a negative pressure is generated at venturi section 26a. Due to this negative pressure, fuel supplied from carburetor 27 is atomized. The atomized fuel is mixed with air in intake passage 26 to produce an air-fuel mixture that is supplied to the combustion chamber of engine 10.

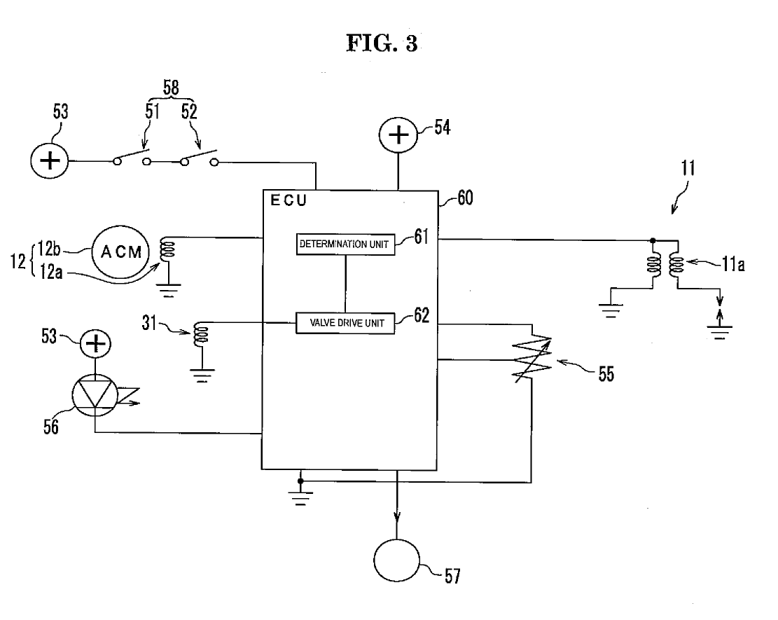

Engine 10 is provided with an ignition device 11 that has an igniter coil 11a, as shown in FIG. 3. The air-fuel mixture supplied to the combustion chamber of engine 10 is compressed, and combusted by ignition device 11. As a result, the crank shaft of engine 10 rotates, thereby producing power. A rotation speed sensor 12 attached to engine 10 detects the rotation speed of the crank shaft of engine 10. Rotation speed sensor 12 may be any device that can detect the rotation speed of engine 10. In this example, rotation speed sensor 12 is formed by a pulser coil 12a and an AC magnet (ACM) 12b, as shown in FIG. 3.

The air-fuel mixture combusted in engine 10 becomes exhaust gas and is discharged to the outside of engine 10 through an exhaust gas passage 40. Exhaust gas passage 40 includes an exhaust pipe 44 connected to engine 10, a muffler 42 and a catalyst section 43 positioned between exhaust pipe 44 and muffler 42. Exhaust gas that reaches catalyst section 43 through exhaust pipe 44 is purified using a catalyst 41 in catalyst section 43. Then, the purified exhaust gas is discharged from muffler 42. The type of catalyst 41 is not particularly limited and is selected appropriately depending on the type, displacement, and the like of motorcycle 1.

An electronically controlled opening/closing valve 30 provided in intake passage 26 opens and closes intake passage 26. In this embodiment, only opening/closing valve 30 is provided to open and close intake passage 26.

Opening/closing valve 30 may be any appropriate device as long as it is driven by electric power and electronically controlled. In this example, opening/closing valve 30 is a so-called solenoid valve, which is one type of electromagnetic valve. As shown in FIG. 3, opening/closing valve 30 is formed by a solenoid coil 31 that activates a valve body. When solenoid coil 31 is not supplied with electric power, the valve body does not block intake passage 26. When solenoid coil 31 is supplied with electric power, the valve body is activated to block intake passage 26 and to shut off the supply of air-fuel mixture from intake passage 26 to engine 10. When engine 10 is running, opening/closing valve 30 is OFF and does not block intake passage 26.

Opening/closing valve 30 may be provided at any location as long as it can reduce the supply of air-fuel mixture to engine 10. For example, it may be positioned closer to air cleaner 25 than carburetor 27 or closer to engine 10 than carburetor 27.

### Control System of Motorcycle 1

A control system of motorcycle 1 is described referring mainly to FIG. 3. Motorcycle 1 is controlled mainly by an ECU (Engine Control Unit) 60 serving as a control unit.

Rotation speed sensor 12 formed by pulser coil 12a and AC magnet 12b sends the detected rotation speed of engine 10 to ECU 60. The rotation speed of engine 10 sent to ECU 60 is displayed on a tachometer 57 connected to ECU 60.

A throttle position sensor (TPS) 55 connected to ECU 60 detects the position of a throttle 29 (FIG. 2) and sends the detected position to ECU 60.

Igniter coil 11a of ignition device 11 is connected to ECU 60. ECU 60 supplies electric power to igniter coil 11a at a timing corresponding to the engine speed output from rotation speed sensor 12, the throttle opening degree output from TPS 55, or the like. ECU 60 is also connected to carburetor 27 as shown in FIG. 2. ECU 60 drives carburetor 27 in accordance with engine speed, throttle opening degree or the like, thereby controlling the amount of fuel supplied. Thus, engine 10 is driven in accordance with the operation of throttle 29 or the like.

ECU 60 is connected to a main power source 53 via a main switch 51 and an engine switch 52. When main switch 51 and engine switch 52 are turned on, electric power is supplied from main power source 53 to ECU 60, and ignition device 11 is turned on. As a result, engine 10 is started.

If engine switch 52 or main switch 51 is turned off while engine 10 is being run, engine 10 is turned off. More specifically, when engine switch 52 or main switch 51 is turned off ignition device 11 is turned off. As a result, engine 10 is stopped. After engine switch 52 or main switch 51 is turned off, electric power is supplied from an auxiliary power source 54 to ECU 60. In this specification, engine switch 52 and main switch 51 may be collectively referred to as a switch 58, and main power source 53 and auxiliary power source 54 may be collectively referred to as a power source 59.

A warning light 56 connected to ECU 60 lights up when an abnormality occurs, such as a power shortage of main power source 53 or auxiliary power source 54.

ECU 60 is provided with a determination unit 61 and a valve drive unit 62. Valve drive unit 62 is connected to solenoid coil 31. Determination unit 61 determines whether or not the rotation speed of engine 10 detected by rotation speed sensor 12 is a determined rotation speed or more, when switch 58 is turned off. When switch 58 is turned off, and determination unit 61 determines that the rotation speed of engine 10 is equal to or more than the determined rotation speed, valve drive unit 62 switches opening/closing valve 30 to the ON position such that intake passage 26 is closed. On the other hand, when switch 58 is turned off, and determination unit 61 determines that the rotation speed of engine 10 is less than the determined rotation speed, valve drive unit 62 leaves opening/closing valve 30 in the OFF position such that intake passage 26 is open. After main switch 55 or engine switch 52 has been turned off, ECU 60 or opening/closing valve 30 is driven by electric power supplied by auxiliary power source 54.

### Operation of Opening/Closing Valve 30

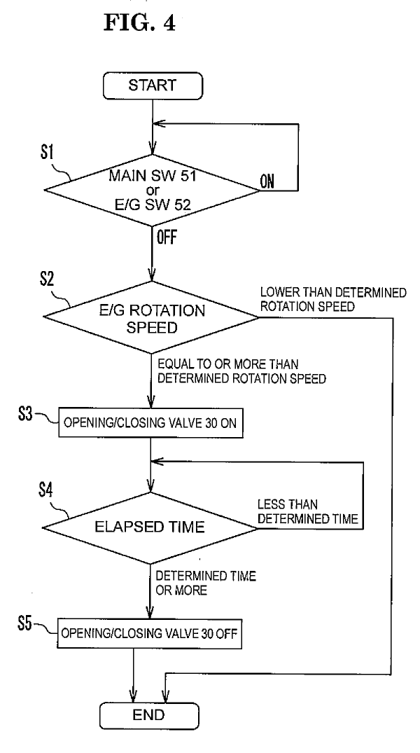

A more detailed explanation is now given with reference to FIG. 4. The state of main switch 51 and engine switch 52 is determined at step S1. When main switch 51 and engine switch 52 are in the ON position at step S1, the routine returns to step S1 again. In other words, while main switch 51 and engine switch 52 are in the ON position, step S1 is repeatedly performed at determined intervals. On the other hand, when at least one of main switch 51 and engine switch 52 is in the OFF position at step Si, the routine proceeds to step S2.

At step S2, determination unit 61 determines the rotation speed of engine 10. When the engine speed is equal to or more than a determined rotation speed, the routine proceeds to step S3. Then, at step S3, opening/closing valve 30 is turned on. That is, power supply to opening/closing valve 30 is started. Thus, intake passage 26, which was open when engine 10 was running, is closed. Accordingly, intake passage 26 is closed and the supply of air-fuel mixture to engine 10 is stopped.

The “determined rotation speed” at step S2 is appropriately set depending on the type of motorcycle 1, and the type, amount, location, etc. of catalyst 41. The “determined rotation speed” is preferably set to a speed at which catalyst 41. does not suffer any significant degradation even if opening/closing valve 30 is held in the OFF position, when the rotation speed of engine 10 is lower than the determined rotation speed. In other words, the “determined rotation speed” is preferably set to a rotation speed at which the amount of unburned fuel that reaches catalyst section 43 is not sufficient to cause any significant degradation of catalyst 41, when the rotation speed of engine 10 is lower than the determined rotation speed.

Moreover, the “determined rotation speed” is more preferably set to a speed at which catalyst 41 does not suffer any substantial degradation even if opening/closing valve 30 is held in the OFF position, when the rotation speed of engine 10 is lower than the determined rotation speed. In other words, the “determined rotation speed” is more preferably set to a rotation speed at which the amount of unburned fuel that reaches catalyst section 43 is not sufficient to cause catalyst 41 to suffer any substantial degradation, when the rotation speed of engine 10 is lower than the determined rotation speed.

The “determined rotation speed” may be set, for example, in a range of approximately 2000-6000 rpm. In one implementation, the “determined rotation speed” is set to 4000 rpm.

Following step S3, an elapsed time from when opening/closing valve 30 was turned on is determined in step S4. When a determined time or more has elapsed from when opening/closing valve 30 was turned on, the routine proceeds to step S5.

In step S5, opening/closing valve 30 is turned off. That is, the power supply to opening/closing valve 30 is shut off.

The “determined time” at step S3 is appropriately set according to the type of motorcycle 1, and the type, amount, location, etc. of catalyst 41. The “determined time” is preferably set such that catalyst 41 does not suffer significant degradation when opening/closing valve 30 is turned off at step S5 after the determined time has elapsed. In other words, the “determined time” is preferably set to a time that ensures that the amount of unburned fuel that reaches catalyst section 43 does not cause catalyst 41 to suffer any significant degradation.

Further, the “determined time” is more preferably set such that catalyst 41 does not suffer any substantial degradation when opening/closing valve 30 is turned off at step S5 after the determined time has elapsed. In other words, the “determined time” is more preferably set to a time that ensures that the amount of unburned fuel that reaches catalyst section 43 does not cause catalyst 41 to suffer any substantial degradation.

The “determined time” may be set, for example, in a range of approximately 10 seconds to 5 minutes, and preferably in a range of approximately 10 seconds to 3 minutes. In one implementation, the “determined time” is set to approximately 1 minute.

On the other hand, when it is determined at step S2 that the rotation speed of engine 10 is lower than the determined rotation speed, the routine ends without performing steps S3-S5. That is, when the rotation speed of engine 10 is lower than the determined rotation speed, opening/closing valve 30 is not turned on (power is not supplied to opening/closing valve 30).

### Operation And Effects

As described above, in this embodiment, if the rotation speed of engine 10 is determined to be less than the determined rotation speed at step S2, electric power is not supplied to opening/closing valve 30, and the routine ends with opening/closing valve 30 in the OFF position. Thus, when the rotation speed of engine 10 is lower than the determined rotation speed and there is no need to close intake passage 26 in order to prevent catalyst 41 from suffering significant degradation, electric power is not supplied to opening/closing valve 30 and electric power consumption of power source 59 is thereby reduced. As a result, the service life of power source 59 is made longer. In addition, power source 59 can have a small capacity and a compact size, and motorcycle 1 can be more compact.

The “determined rotation speed” at step S2 is, as described above, a speed at which catalyst 41 does not suffer significant deterioration even if opening/closing valve 30 is held in the OFF position, when the rotation speed of engine 10 is lower than the determined rotation speed. Therefore, when the rotation speed of engine 10 is determined at step S2 to be lower than the determined rotation speed, catalyst 41 does not suffer significant deterioration even if opening/closing valve 30 is not closed.

On the other hand, when the rotation speed of engine 10 is determined to be equal to or more than the determined rotation speed, opening/closing valve 30 is turned on and intake passage 26 is closed. Accordingly, if the engine speed is relatively high when engine 10 is stopped, and a large amount of unburned fuel would reach catalyst section 43 if nothing was done, opening/closing valve 30 is closed and a large amount of unburned fuel is prevented from reaching catalyst section 43. As a result, thermal degradation of catalyst 41 is effectively prevented.

In other words, in this embodiment, opening/closing valve 30 is driven only when it is determined at step S2 that the rotation speed of engine 10 is equal to or more than the determined rotation speed, thereby reducing electric power consumption of power source 59 and preventing thermal degradation of catalyst 41.

Moreover, in this embodiment, opening/closing valve 30 is turned off in step S3 after a determined time has elapsed since it was turned on. Therefore, the length of time for which power is supplied to opening/closing valve 30 is made relatively short and electric power consumption of power source 59 is more effectively reduced.

In addition, because opening/closing valve 30 is turned off after the determined time has elapsed, there is no need to separately provide a special sensor or the like, resulting in a reduced cost.

Further, opening/closing valve 30 is reliably turned off after the determined time period has elapsed. Accordingly, motorcycle 1 is prevented from being left unattended with opening/closing valve 30 held in the ON position.

In a stationary engine, by contrast, as described on the right side of the twentieth line of page two of JP-UM-B-6-619, a stop operation is performed by interrupting supply of fuel to engine 10 using an electromagnetic cock. As a result, when the engine stop operation is performed, there is a unique state in which the engine is in a fixed speed running state at a constant relatively high rotation speed, which is different from the present invention in which the engine is turned off by turning off an ignition device. As a result, when the engine stop operation is performed in the stationary engine, it is difficult to conceive of a case where the engine rotation speed would be low enough that substantial thermal degradation of the catalyst does not occur. Thus, with the stationary engine, when the engine stop operation is performed, it is favorable to always turn the solenoid valve on. The present invention, by contrast, is particularly beneficial when engine 10 is turned on/off by turning an ignition device on/off using a switch.

A solenoid valve is simple in structure and inexpensive. Therefore, use of a solenoid valve as opening/closing valve 30 as in this embodiment makes it possible to give motorcycle 1 a simple structure that is inexpensive.

### Other Modified Examples

Motorcycle 1 has been described as an example of a vehicle according to the invention. However, the vehicle according to the invention may be a straddle-type vehicle other than a motorcycle such as an ATV (All Terrain Vehicle) and the like. However, because of restrictions with respect to the size of the battery, the invention is particularly favorably used in a motorcycle that has a displacement of 250 cc or less.

An example has been described in which the “opening/closing valve” is a solenoid valve. However, any opening/closing valve may be used as long as it is driven by electric power. For example, the opening/closing valve may be a valve that is opened and closed by an electric motor or by using an electronically controlled hydraulic cylinder or an air cylinder.

An example has been described in which opening/closing valve 30 is turned on for just the determined period when the rotation speed of engine 10 is equal to or more than the determined rotation speed. However, the invention is not limited to this structure. For example, the rotation speed of engine 10 may be monitored and opening/closing valve 30 may be held in the ON position until the rotation speed of engine 10 becomes lower than a determined rotation speed. Furthermore, a fuel concentration sensor for detecting the concentration of unburned fuel may be separately provided at catalyst section 43, and opening/closing valve 30 may be held in the ON position until the detected fuel concentration becomes lower than a determined concentration.

The invention is applicable to vehicles and is particularly applicable to motorcycles.

While particular embodiments of the invention have been described, it should be understood that these embodiments are exemplary, and not restrictive. Various modifications will be apparent to those of skill in the art and are within the scope of the present invention as set forth in the following claims.

1. A vehicle comprising:
a fuel tank that stores fuel;
an engine;
an intake passage that supplies air to the engine;
a fuel supply device that is connected to the fuel tank and supplies the fuel to the intake passage;
an electronically controlled opening/closing valve that opens and closes the intake passage;
a control unit that controls the opening/closing valve;
an exhaust gas passage that is connected to the engine and through which exhaust gas from the engine passes;
a catalyst disposed inside the exhaust gas passage;
a switch that turns on/off the engine; and
a rotation speed sensor that detects a rotation speed of the engine and outputs the detected rotation speed of the engine to the control unit, wherein the control unit comprises:
a determination unit that determines whether the rotation speed of the engine is equal to or more than a determined rotation speed when the switch is turned off; and
a valve drive unit that switches the opening/closing valve on to close the intake passage when the determination unit determines that the rotation speed of the engine is equal to or more than the determined rotation speed, and switches the opening/closing valve off to open the intake passage when the determination unit determines that the rotation speed of the engine is less than the determined rotation speed.

2. The vehicle according to claim 1, wherein
the engine has an ignition device that ignites the fuel, and
the switch turns the ignition device on/off to turn the engine on/off.

3. The vehicle according to claim 1, wherein the opening/closing valve includes a solenoid valve.

4. The vehicle according to claim 1, wherein the fuel supply device is a carburetor.

5. The vehicle according to claim 1, wherein the vehicle is a motorcycle.

6. A control device for a vehicle, the vehicle comprising:
a fuel tank that stores fuel;
an engine;
an intake passage that supplies air to the engine;
a fuel supply device that is connected to the fuel tank and supplies the fuel to the intake passage;
an electronically controlled opening/closing valve that opens and closes the intake passage;
an exhaust gas passage that is connected to the engine and through which exhaust gas from the engine passes;
a catalyst disposed inside the exhaust gas passage;
a switch that turns on/off the engine; and
a rotation speed sensor that detects a rotation speed of the engine,
wherein the control device comprises:
a determination unit that determines whether the rotation speed of the engine is equal to or more than a determined rotation speed when the switch is turned off; and
a valve drive unit that switches the opening/closing valve on to close the intake passage when the determination unit determines that the rotation speed of the engine is equal to or more than the determined rotation speed, and switches the opening/closing valve off to open the intake passage when the determination unit determines that the rotation speed of the engine is less than the determined rotation speed.

7. A control method for a vehicle, the vehicle comprising:
a fuel tank that stores fuel;
an engine;
an intake passage that supplies air to the engine;
a fuel supply device that is connected to the fuel tank and supplies the fuel to the intake passage;
an electronically controlled opening/closing valve that opens and closes the intake passage;
an exhaust gas passage that is connected to the engine and through which exhaust gas from the engine passes;
a catalyst disposed inside the exhaust gas passage;
a switch that turns on/off the engine; and
a rotation speed sensor that detects a rotation speed of the engine,
the control method comprising:
a step of determining whether the rotation speed of the engine is equal to or more than a determined rotation speed when the switch is turned off; and
a step of switching the opening/closing valve on to close the intake passage when it is determined in the determining step that the rotation speed of the engine is equal to or more than the determined rotation speed, and switching the opening/closing valve off to open the intake passage when it is determined in the determining step that the rotation speed of the engine is less than the determined rotation speed.
